(19) United States
(12) Patent Application Publication
(10) Pub. No.: US 2014/0258015 A1
(43) Pub. Date: Sep. 11, 2014

(54) SELECTIVELY LINKING AUCTIONS TO END AT THE SAME TIME

(71) Applicant: AUCTION.COM, LLC., Irvine, CA (US)

(72) Inventor: Robert Friedman, Irvine, CA (US)

(73) Assignee: Auction.com, LLC., Irvine, CA (US)

(21) Appl. No.: 13/794,460

(22) Filed: Mar. 11, 2013

(51) Int. Cl. G06Q 30/08

(52) U.S. Cl. CPC G06Q 30/08
USPC 705/26.3

(57) ABSTRACT

An auction forum in which multiple auctions are selected to end at a common end time based on a determination that the selected auctions are likely to interest a common set of prospective bidders.

### TECHNICAL FIELD

Examples described herein relate to online markets, and more specifically, to a system and method for selectively linking auctions to end at a same time.

### BACKGROUND

Numerous online auction forums exist that enable consumers and sellers to transact for various kinds of items, such as collectibles, electronics and other goods or services.

### BRIEF DESCRIPTION OF THE DRAWINGS

FIG. 1 illustrates a system for implementing an auction forum in which auctions for items are selectively linked to end at a same time.

FIG. 2 illustrates an example method for linking auctions that are of interest to a common set of prospective buyers so that the auctions end at a common end time.

FIG. 3 illustrates an example method in which linked auctions can be extended in accordance with completion rules so that the auctions are completed at a same time.

FIG. 4 illustrates an example bidder interface that provides for a linked set of auctions, in accordance with one or more embodiments.

FIG. 5 is a block diagram that illustrates a computer system upon which embodiments described herein may be implemented.

### DETAILED DESCRIPTION

Embodiments described herein provide for an auction forum in which multiple auctions are selected to end at a common end time based on a determination that the selected auctions are likely to be of interest to a common set of prospective bidders.

Embodiments as described herein recognize that in many auction forums, bidders sometimes have interest in multiple items that are to be auctioned, but face a decision as to which item they should bid on because the auctions of interest occur at different times. For example, a prospective purchaser for a particular item may identify multiple auctions that are of interest. But as the auctions may occur at different time, individual buyers may have to elect to forego bidding on some auctions in favor of focusing on specific auction(s). In one scenario, for example, a prospective buyer may choose to bid on an item that is being auctioned earlier in time than another auction, out of fear that he or she will lose a later auction for a similar item, even if the item of the later auction is more desirable. Thus, the bidder makes a strategic decision to bid on a less desired item in order to increase the chance that the bidder will win an auction, rather than risk losing the auction that is of most interest, and walking away empty-handed.

Examples are described in which auctions for items that are likely of interest to a common set of bidders are programmatically identified and linked. The linked auctions are then conducted to end at the same time. This allows bidders that are likely interested in multiple auctions to bid on each item that they are interested in, rather than to be selective or strategic as to which auction to bid on.

In one example, items that are to be auctioned are analyzed to identify a band or linked set of auctions. Each of the auctions in the band can provide an item that is likely to be of interest to a common set of bidders. Thus, items of an auction band (i.e., linked set of auctions) may share many salient characteristics. The items of the auction band may be auctioned in a manner that designates each auction in the band to end at a same time.

In one example, multiple items that are to be auctioned by different sellers are linked. For each item in the set, a corresponding auction is initiated, and a set of completion rules are implemented. The set of completion rules can determine events or conditions for which the particular auction is to be extended. The auction for each item can be monitored for the occurrence of the event or condition in which that auction is extended. In response to the corresponding auction for any item in the set of multiple items being extended, the auction for all other items in the set are also extended, so that the corresponding auction for each item in the set ends at a same time.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Auction Architecture

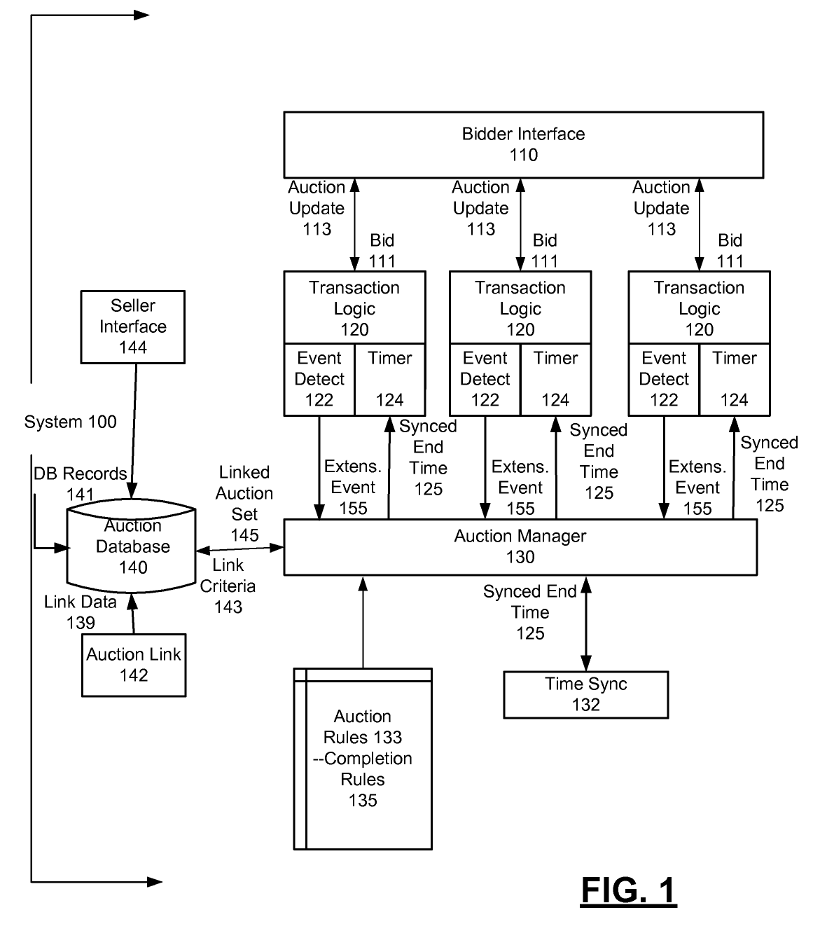

FIG. 1 illustrates a system for implementing an auction forum in which auctions for items are selectively linked to end at a same time. A system 100 such as shown by an example of FIG. 1 can be implemented in connection with an online auction service for any type of commercial item, such as, for example, real property items, (e.g., homes, real-estate notes, commercial property), motor vehicles (e.g., automobiles, motorcycles, boats), consumer electronics, collectibles, or clothing.

In an example of FIG. 1, system 100 includes functionality that can be implemented by processes, logical components and/or modules. In an example of FIG. 1, system 100 includes a bidder interface 110, transaction logic 120, an auction manager 130, and an auction database 140. The auction database 140 can retain records that identify items that are to be auctioned, and/or items which are undergoing or have completed an auction. In some implementations, the auction database 140 is coupled to a seller interface 144. The seller interface 144 enables individual sellers to create records that identify an item for auction. The seller interface 144 can enable sellers to specify information 143 that identifies the item being auctioned, the terms of sale, and other parameter such as a reserve price (which can be hidden from prospective bidders). The database 140 can retain records 141 of auctions in various states, including pre-auction, in-auction (auction initiated) and post-auction (auction completed).

The bidder interface 110 includes functionality for enabling bidders to view and participate in an in-progress auction. Accordingly, the bidder interface 110 can include functionality for enabling a bidder to specify a bid, and to monitor in real-time the current value of an item being auctioned. The bidder interface 110 can be provided as, for example, a webpage that includes functional elements for enabling the users to provide input (e.g., bids) and to view real-time updates for the in auction while it is in progress. In variations, the bidder interface 110 can be provided as application content, such as through a display or panel of a network-enabled application.

The transaction logic 120 can implement operations for progressing the auction towards completion. As shown by an example of FIG. 1, multiple instances of transaction logic 120 can be implemented at a given time in order to conduct an auction and to progress the auction towards completion. The transaction logic 120 can be coupled to database 140 to receive information from records 141 that are to be auctioned. The transaction logic 120 can include functionality to (i) initiate an auction, (ii) advance the auction towards completion, and (iii) end or complete the auction when certain conditions are satisfied (e.g., after completion of time and/or satisfaction of completion rules). In addition to receiving and processing bids 111, the transaction logic 120 provides an auction update 113 to the bidders that are viewing or participating in a particular auction. The auction update 113 can include information such as a current price for the item being auctioned, an amount of time remaining in the auction, and/or comments from other users. Other information that can be updated by the transaction logic 120 and published through the bidder interface 110 include identifiers for active bidders, recent bid amounts, current bid increment (which optionally can change based on dynamic bid increment adjustments), comments from other users, and information from other auctions that may be in various states (e.g., pre-auction versus in-progress). The auction update 113 can be published through the bidder interface 110 to the population of users.

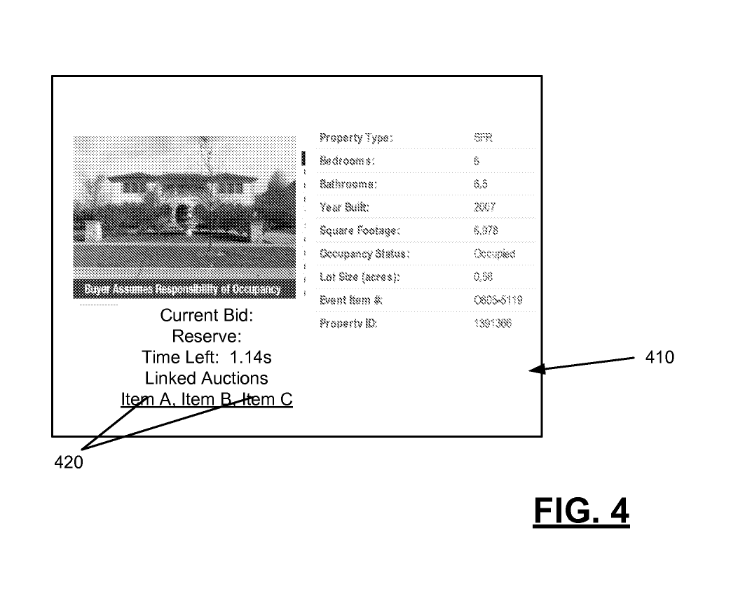

As shown by an example of FIG. 4, the bidder interface 110 (e.g., web page) can display links or content for multiple auctions that are banded to end at a same time. For example, the bidder interface can display several banded and ongoing auctions on one presentation (e.g., web page). Alternatively, the bidder interface 110 can, for example, display auction content for one auction, and include links to enable the viewer to readily access other auctions of the particular band.

In some embodiments, transaction logic 120 can include an event detector 122 and a timer 124. The event detector 122 can operate to detect events (or conditions) that after the progress of the auction. The events can be predetermined. Examples of such events include receipt of a bid, receipt of a bid any given time period relative to the end of the auction, receipt of the bid that pushes the current price above a reserve, and participation by one or more users beyond a set threshold.

The timer 124 maintains the time remaining before the auction completes. As described with some examples, the timer 124 can be reset, or adjusted while the auction is in progress. As described below, the timer 124 can be managed by the auction manager 130. The timer 124 can be configured to respond to the occurrence of certain events, including events detected with individual auctions, or events detected with banded or linked auctions 145.

In an example of FIG. 1, the auction manager 130 coordinates and synchronizes the progress of multiple auctions. In particular, the auction manager 130 triggers transaction logic 120 to initiate individual auctions, so that individual auctions progress towards completion in accordance with a set of auction rules. The auction manager 130 operates to control execution of the transaction logic 120, such as by initiating the timer 124 and/or resetting the timer as the auction progresses. In particular, the auction manager 130 can reset timers 124 for the transaction logic 120 of multiple auctions, and further synchronize the timers 124 for the different auctions.

In an example of FIG. 1, auction manager 130 initiates instances of transactional logic 120, and communicates auction rules 133 to the transaction logic 120 in order to progress the corresponding auctions towards completion. The auction rules 133 can also include completion rules 135, which specify rules or conditions that affect the timer 124 maintained by each auction. In this way, the completion rules can specify when a particular auction is to be extended based on the occurrence of a designated event. In one example, completion rules 135 cause corresponding transaction logic 120 to extend an auction in the event an incoming bid is received in a given timeframe. For example, the completion rules 135 may specify that an auction will end at a given time, unless a bid is received in the last minute (or other duration), in which case the auction is extended.

In an example of FIG. 1, an auction link component 142 can analyze the records 141 of the database 140 to determine items that can or should be linked based on one or more criterion. In one aspect, the auction link component 142 determines records 141 for items that are likely of interest to a common set of prospective bidders. The corresponding auction for these items are records can be linked or banded and communicated to the auction manager 130 as a linked auction set 145.

In one implementation, the auction link component 142 can identify items that share multiple characteristics. Items that have a sufficient similarity in designated characteristics can be deemed to be of interest to a common set of bidders. The shared characteristics can vary for different kinds of items. For example, in real property, characteristics can include locality of the real property, the price or price range (e.g., expect the sale price, reserve price etc.), the type of property (e.g. condominium versus single dwelling), and size (e.g., lot, number of bedrooms etc.). With consumer goods, the characters this can include a brand or comparable product models. Thus, the auction link component 142 can link items by sub-category and class, as well as by characteristics.

In another implementation, the auction link component 142 can identify multiple items that are likely of interest to a particular bidder profile. The bidder profile can be defined by, for example, gender, interest, age, or affluence. Alternatively, the bidder profile can be defined in part by taste.

Still further, a profile to link multiple auction items can be based on prior auction history. For example, specific goods or collectibles may be known to be of interest to a common set of bidders. The auction link component 142 can identify such items on an ongoing basis, and link to items based on past history in which certain users actively seek to bid on items of that kind. The auction link component 142 can programmatically identify those auction records 141 that likely are of interest to a common set of bidders. Those records that are deemed to have a common set of interested bidders can be linked by linked data 139. The determinations of the auction link component 142 as to which items should be linked can be based on a variety of parameters, some of which may be specific to the type or class of the item that is being auctioned. For example, in the case of real property, the determination of the items to the linked include the geographic location of the property, the type and sub-category of the property (e.g., single dwelling versus condominium), the size of the property (e.g., number of bedrooms or baths, parcel size) and/or the expected price or reserve price. Numerous such examples are contemplated in described elsewhere in this application.

In this way, auction link component 142 can link records for auctions together, based on various criteria. The auction manager 130 can operate to identify linked sets of auctions 145. The auction manager 130 can further control the transaction logic 120 so that each auction in the linked set of auctions 145 completes at the same time. In one implementation, auction manager 130 determines a set of linked auction items for a particular category (e.g., geographic category, product type etc.) and then initiates the auctions for each item in the particular category at the same time. In variations, the auction manager 130 determines from the database 140 those auction items that are linked on an ongoing basis, and then links the completion of those auctions when some or all of the auctions are in progress.

The auction manager 130 can initiate individual auctions of the linked set 145, and further synchronizes completion of the linked auctions 145 through the transaction logic 120. In some examples, the auction manager 130 can synchronize the operations of multiple instances of transaction logic 120 (e.g., functionality for given auction), so that the progress or completion of auctions that are linked are synchronized to end at the same time. In some variations, the individual auctions of the linked auction set 145 can end at the same time, but begin or be initiated different times.

The auction manager 130 can utilize time synchronization logic 132 to synchronize the end time of each auction in the linked set 145. The auction manager may also utilize the time synchronization logic 132 to initiate the auctions of the linked set 145 at the same time. The auction manager 130 can reset the timer 124 for the transaction logic 120 of each auction in the linked set 145 in order to configure the particular auction process to end (and possibly start) at the same time.

As another addition or alternative, each auction in the linked auction set 145 can be extended by the occurrence of a designated event. For example, as described for some examples below, each auction of the linked set 145 can be extended based on the occurrence of an event that corresponds to a bid being received at a given time before the natural completion of the particular auction (e.g., bid received in last minute).

In some examples, the event detector 122 of the transaction logic 120 for each auction in the linked set 145 operates to detect designated events that serve to alter the manner in which the corresponding auction progresses towards completion. In particular, the event detector 122 can detect events to extend the timeline of a corresponding auction. The timer 124 can maintain a timeline for progressing a corresponding auction towards completion, and the timer can be reset based on timing signals from the auction manager 130.

In some embodiments, the auction manager 130 can implement completion rules 135 that provide for extending the time during which a given auction is to end based on the occurrence of certain designated events. The event detector 122 for the transaction logic 120 of each auction in the linked set can operate to detect the occurrence of a designated extension event 155. For example, the event detector 122 can detect when bids are received in a given time period prior to the natural completion of the corresponding auction. The extension event 155 can be communicated to the auction manager 130. In turn, the auction manager 130 determines how the auction is to progress based on the completion rules 135 (e.g., completion rules to extend the completion time based on the extension rules). The timing of the auction is determined, and the time synchronization logic 132 is triggered to generate the synchronized end time 125 to the transaction logic 120 of each auction in the linked set 145. The timer 124 for each auction of the linked set 145 can then be extended by the same amount, so that each auction in the linked set 145 ends at the same time.

As a variation, completion rules can provide for multiple conditions or events as requisites for alteration to the end times of an auction. For example, some auctions may be extended automatically, or through programmatic bidding, when the reserve price is not met. Thus, the completion rules 135 can specify the condition of whether the reserve price is met in determining if an auction is to be extended.

In one implementation, the bidder interface 110 may include functionality or other features to facilitate the individual bidders to view each of the auctions and link set 145 through the bidder interface. For example, the webpage for each auction of the link set 145 can include links, or portions of other interfaces (e.g., web pages), corresponding to auctions of other items in the linked set 145. In this way, prospective bidders can view or participate in one of the auction of the linked set 145, and then toggle or access other auctions of the linked set 145 as each of the auctions in the linked set 145 progress towards completion.

Methodology

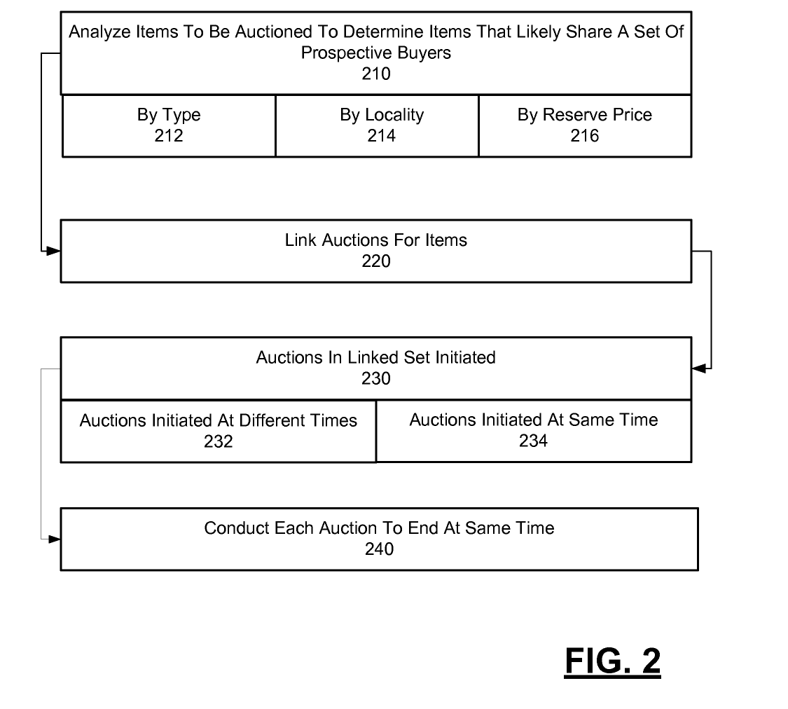

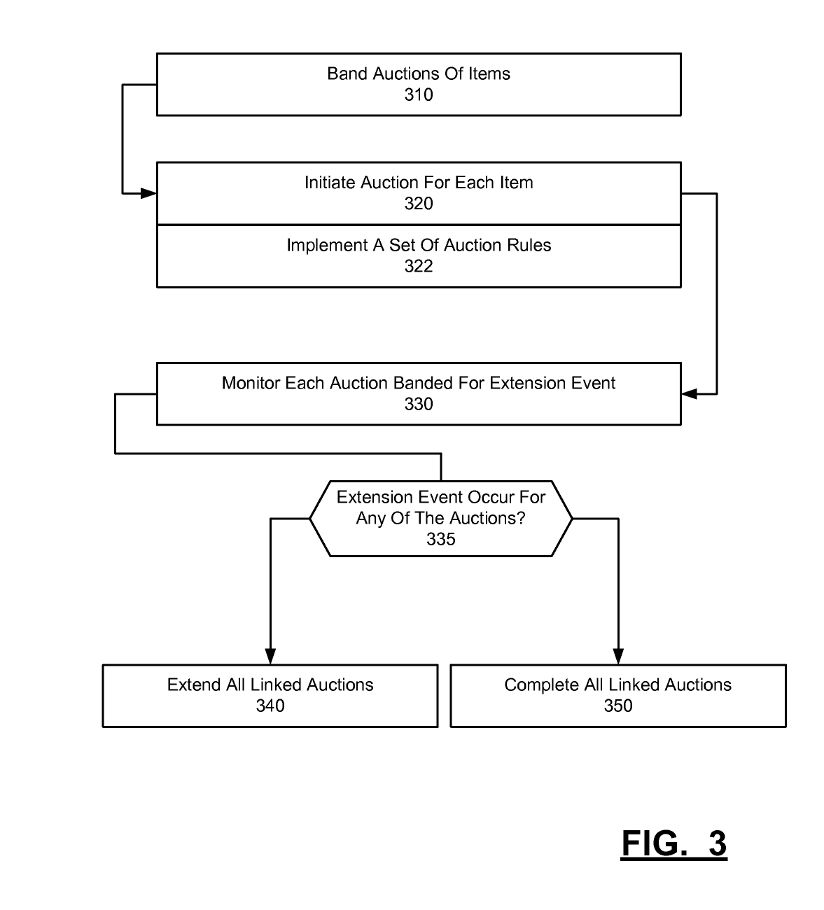

FIG. 2 illustrates an example method for linking auctions that are of interest to a common set of prospective buyers so that the auctions end at a common end time. FIG. 3 illustrates an example method in which linked auctions can be extended in accordance with completion rules and completed at a same time. Methods such as described by examples of FIG. 2 and FIG. 3 can be implemented using, for example, a system such as described by an example of FIG. 1. Accordingly, reference may be made to elements of system 100 for purpose of illustrating suitable components or elements for performing a step or sub step being described.

With reference to FIG. 2, items that are to be auctioned are analyzed for characteristics that indicate those items are likely of interest to a common set of bidders (210). One characteristic that can be used to link a set of auctions to end at the same time includes type or category of the item being auctioned (e.g., vintage vehicles, jewelry) (212). As an addition or alternative, another characteristic for identifying auctions to band together includes the locality or geographic region where the item being auctioned is located (214). For example, locality or geographic region can be used to band auctions for homes or other real property together. Still further, another example characteristic of an item being auctioned includes reserve price (or alternatively expected reserve price)/.

In some examples, information that is descriptive of the items (e.g., as maintained by records 141 of the auction database 140) can be analyzed. The form of analysis can include text analysis, metadata analysis, or inspection of fields that are indicative of certain characteristics. The characteristics that are used for data analysis can be specific to the auction format, or to the item (or category of items) that is being auctioned. In real property auctions, for example, characteristics such as geographic location, lot size, and building size are examples of characteristics that may be salient for purpose of determining whether individual items of real property are of interest to a common set of bidders. By way of example, the auction analysis component 142 can analyze information from the auction database 140 from records 141. In the context of real property auctions, the records 141 may be descriptive of homes that are to be auctioned, and common characteristics for banding auctions can be based on characteristics such as geographic region, lot size, home size and/or type. Thus, for example, auctions for homes in a given neighborhood or city that have a common size (e.g., three bedroom-two bath) and reserve price range can be banded together as the homes are likely to be of interest to a common set of prospective buyers.

Based on characteristics identified in (210), multiple auctions can be linked in the given time period (220). When linked, timers for the individual auctions can be synchronized so that each of the auctions and the same time. Additionally, interfaces for the individual auctions can link, or otherwise display other auctions in the band. Thus, for example, bidders may be able to view multiple auctions of the band at one time, or use link features (e.g., such as provided on a web page) to toggle between one auction and another. Still further, the auctions in the band can be displayed or rendered together in one presentation, such as in a dashboard. As another addition or variation, auctions that are banded can be initiated at the same time. Thus, for example a band of auctions may both start and end at the same time.

Once linked, the auctions in the linked set are initiated (230). Depending on implementation, the auctions of the linked set can be started at different times, but then synchronized to end at the same time (232). In a variation, the auctions of the linked set can be started at the same time and completed at the same time (234).

Once initiated, each auction in the linked set progresses towards completion and ends at the same time (240). By ensuring bidders that each auction in the band ends at the same time, individual bidders can participate in multiple auctions at the same time (or concurrently) in order to obtain a particular item (or kind of item) that is of interest. In contrast to conventional approaches, bidders can participate and/or follow multiple auctions in an attempt to get an item of interest. This allows the individual bidder to gauge whether, for example, a particular item that is of most interest is obtainable through a corresponding auction, or whether the bidder should settle for a lesser item that is more obtainable. As each auction will end at the same time, the individual bidders will have the opportunity to bid on each auction as they see fit, rather than be strategic or selective as to which auction they will participate in.

With reference to FIG. 3, auctions for a given set of items may be linked, using consideration such as described with an example of FIG. 2 or elsewhere in this application (310). An auction may be initiated for each item in the linked set (320). Each auction may be conducted in accordance with a set of rules (322). In particular, the set of rules may dictate how the auction is to be conducted or completed. For example, the rules may allow for individual auctions to be extended if, for example, a bid is received in a given duration of time before the auction is to otherwise expire. As a variation, the rules may also provide for a reserve price to be met before the auction can be extended. Conversely, the rules may provide for the auction to be extended automatically if the reserve price is not met.

Each auction in the band can be monitored for the occurrence of an event or condition that would extend that particular auction, in absence of that auction being banded). For example, the event detector 122 of transaction logic 120 can monitor for events such as incoming bids, and record parameters of the incoming bid. The event detector 122 can also determine whether certain conditions are present (e.g., proximity to it auction completion, whether on not reserve price has been met etc.) to merit, for example, an extension or other alteration to the end time of the auction.

Accordingly, at a given time, a determination can be made as to whether an event has occurred with any one of the auctions in the linked set 145 that would otherwise extend the end time of that auction (335). The determination can be made repeatedly, such as by way of polling each transaction logic 120.

If the determination is that one or more of the auctions receives an event that is to extend the completion time for that auction (if no banding occurs), then each auction in the band is extended in synchronized fashion with the auction that was extended as a result of the occurrence of the event occurred (340). Thus, for example, if three auctions are banded together, and one of the auctions becomes extended at any given instance, the other two auctions are also extended so as to end at the same time. In the following seconds, if another one of the auctions in the band gets extended, all three auctions again are extended in synchronized fashion. It is possible for one of the auction in the band to be extended repeatedly, even though no extension event occurs within that auction. By extending each auction in lockstep with other auctions that are extended in the band, the bidder is provided the opportunity to maintain participation and ability to engage multiple auctions for a particular kind of item.

If each of the auctions in the band is able to reach completion without further extensions, then all of the auctions in the band have ended (350).

### EXAMPLE

FIG. 4 illustrates an example bidder interface in which a banded auction is displayed. In the example provided, the bidder interface 110 can provide a webpage where an item or set of web pages were items in a given band are auctioned. In the example provided, the items can correspond to homes, in a particular geographic region. Descriptive information may accompany the record for the item being auctioned. For example in the case of real property, the characteristics that are deemed salient can include property type, number of bedrooms, number bathrooms, the year built, the square footage, the occupancy status, and the lot size. From the information provided, one or more examples provide that other options that are likely of interest to a common set of bidders are identified.

In the example of FIG. 4, a bidder interface 410 is provided as a web page or application page, and depicts auction content for a corresponding auction. The auction may be linked with other auctions to end at the same time. In the example provided, the interface 410 for the particular auction includes links 420 to the other auctions of the same band. For example, the links 420 can open a browser or application window to view real-time events occurring with another auction of the band that is in progress. Thus, the links 420 can be configured and presented with the auction content as a mechanism for enabling the user to toggle or even simultaneously view and/or participate in multiple auctions of the particular auction band.

Computer System

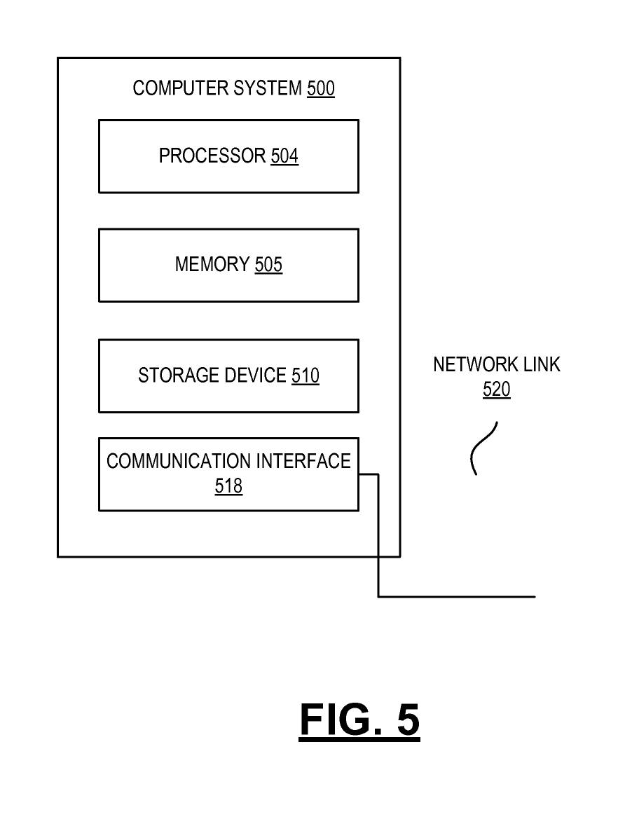

FIG. 5 is a block diagram that illustrates a computer system upon which embodiments described herein may be implemented. For example, in the context of FIG. 1, system 100 may be implemented using one or more servers such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wireline). The communication interface 518 may communicate with bidders and auction participants using, for example, the Internet.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for conducting an auction forum, the method being implemented by one or more processors and comprising:
(a) programmatically analyzing a database of items to be auctioned in order to determine that a set of multiple items are likely to be of interest to a common set of prospective buyers;
(b) linking the set of multiple items to be auctioned so that an auction for each item in the set of multiple items has a common end time; and
(c) conducting the auction for each item in the set of multiple items so that the auctions all end at the common time.

2. The method of claim 1, wherein (a) includes identifying items by a type and by a locality.

3. The method of claim 2, wherein the type corresponds to a type of real property, and wherein the locality can include a geographic region.

4. The method of claim 1, wherein (a) includes identifying items by a type and by an expected sale price or a reserve price.

5. The method of claim 1, wherein the items in the set of multiple items are provided by different sellers.

6. A method for conducting an auction forum, the method being implemented by one or more processors and comprising:
linking a set of multiple items that are being auctioned or scheduled to be auctioned by different sellers wherein a first auction for one of the items in the set of multiple items is initiated at a different start time than a second auction for another item in the set of multiple items; and
synchronizing a common end time for each auction of an item in the set of multiple items such that each auction stops accepting new bids at the common end time.

7. The method of claim 6, wherein linking the set of multiple items includes linking at least one of the items in the set of multiple items after the auction for another item in the set of multiple items has initiated.

8. The method of claim 6, wherein linking the set of multiple items includes linking at least one of the items includes linking items by a type and/or by a locality.

9. The method of claim 8, wherein the type corresponds to a type of real property, and wherein the locality can include a geographic region.

10. The method of claim 6, wherein linking the set of multiple items includes identifying items by a type and by an expected sale price or a reserve price.

11. (canceled)

12. A method for conducting an auction forum, the method being implemented by one or more processors and comprising:
linking a set of auctions for multiple items so that each auction in the set ends at a first end time;
for each item in the set of multiple items, (i) initiating a corresponding auction, and (ii) implementing a set of completion rules that extend that auction from the first end time to a second end time in response to an occurrence of an event or condition;
monitoring the corresponding auction for each item in the set of multiple items for the occurrence of the event or condition in which that auction is extended;
when the corresponding auction for any item in the set of multiple items is extended to the second end time, extending the auction for all other items in the set of multiple items to the second end time.

13. The method of claim 12, wherein the auction for each item in the set of multiple items includes a same set of completion rules for extending that auction.

14. The method of claim 13, wherein implementing the set of completion rules includes extending the auction in response to receiving a bid in a designated time period before the auction is to end without further extension.

15. The method of claim 13, wherein implementing the set of completion rules includes extending the auction in response to a set of conditions that include a reserve price not being met.

16. The method of claim 12, wherein linking the set of auctions includes analyzing information provided with each item being auctioned in the set of auctions, and determining, from the information, that each item shares one or more predetermined characteristics that are indicative of common interest among a group of bidders.

17. The method of claim 16, wherein analyzing the information includes determining, from the information, a geographic location for each item being auctioned in the set of auctions.

18. A computer system comprising:
a memory resource that stores a set of instructions;
one or more processors;
wherein the one or more processors use the set of instructions stored in the memory resource to:
link a set of multiple items that are being auctioned or scheduled to be auctioned by different sellers wherein a first auction for one of the items in the set of multiple items is initiated at a different start time than a second auction for another item in the set of multiple items; and
synchronize a common end time for each auction of an item in the set of multiple items such that each auction stops accepting new bids at the common end time.

19. The computer system of claim 18, wherein the computer system is provided as part of an auction service using the Internet.

20. A computer-readable medium for conducting an auction forum, the computer-readable medium storing instructions, that when executed by one or more processors, cause the one or more processors to perform operations comprising:
(a) programmatically analyzing a database of items to be auctioned in order to determine that a set of multiple items are likely to share a common set of prospective buyers;
(b) linking the set of multiple items to be auctioned so that an auction for each item in the set of multiple items has a common end time; and
(c) conducting the auction for each item in the set of multiple items so that the auctions all end at the common time.
